(19) United States
(12) Patent Application Publication
(10) Pub. No.: US 2012/0038966 A1
(43) Pub. Date: Feb. 16, 2012

(54) ELECTROCHROMIC MODULE AND DISPLAY DEVICE INTEGRATED WITH THE SAME

(75) Inventors: YU-CHOU YEH, TAOYUAN COUNTY (TW); CHAO-YI WANG, TAOYUAN COUNTY (TW)

(73) Assignee: J TOUCH CORPORATION, TAOYUAN COUNTY (TW)

(21) Appl. No.: 12/952,525

(22) Filed: Nov. 23, 2010

(30) Foreign Application Priority Data
Aug. 10, 2010 (TW) 099126636

(51) Int. Cl. G02F 1/153

(52) U.S. Cl. 359/268; 359/265; 359/273; 977/742; 977/952

(57) ABSTRACT

In an electrochromic module and a display device integrated with the electrochromic module, the electrochromic module is installed on a surface of the display device and includes a first transparent substrate and a second transparent substrate. A transparent conductive element and an electrochromic layer are disposed between the two substrates, and the material of the electrochromic layer is prepared by dissolving an indicator into a solvent, and electrons are used to change the valence of ions inside the material, such that a coloration is resulted from reduction and oxidation caused by supplying and removing electrons to the ions respectively, and the electrochromic coloration rate is quicker and more uniform than present existing electrochromic materials. Unlike achromic mechanism that produces a decoloration by the oxidation and reduction of organic electrochromic materials, the electrochromic module and the display device have the advantages of a quick decoloration and a small driving voltage.

### CROSS-REFERENCE TO RELATED APPLICATIONS

This non-provisional application claims priority under 35 U.S.C. §119(a) on Patent Application No(s). 099126636 filed in Taiwan, R.O.C. on Aug. 10, 2010, the entire contents of which are hereby incorporated by reference.

### BACKGROUND OF THE INVENTION

1. Field of the Invention

The present invention relates to an electrochromic module, and more particularly to an electrochromic module having both oxidizing and reducing materials and a display device applying the electrochromic module.

2. Description of the Related Art

Electrochromism (EC) refers to the phenomenon displayed by some electrochromic materials of reversibly changing color caused by a light absorption or desorption under the effect of a current or an electric field. The electrochromic materials can be divided into inorganic electrochromic materials and organic electrochromic material that must have the following properties in practical applications: (1) good electrochemical redox reversibility, (2) quick color change response time, (3) reversible color change, (4) high sensitivity of color change, (5) long cycle life, (6) certain memory storage function, and (7) good chemical stability.

At present, electrochromic patented technologies adopt oxides or hydroxides of transition elements or their derivatives to produce inorganic solid-state films or mix their organic compounds/electrolyte material to produce composite materials, and provide electrons or an ion source (an electrolyte or a second electrochromic material) to allow ions to enter into the crystal lattice to achieve an color change effect of the electrochromic materials such as WO₃, Ni(OH)₂, and Prussian blue. Besides the aforementioned electrochromic materials, inorganic electrochromic materials have a stable characteristic, and whose light absorption change is caused by dual addition and dual removal of ions and electrons, The organic electrochromic materials include polyaniline, vioiogen and rare-earth phthalocyanine and come with a variety of colors. In other words, the organic material is produce by oxidation and reduction. Although the organic material provides a faster reaction, it has issues of environment protection and toxicity.

The principle of present well-known stereo image display technologies adopts a binocular disparity for receiving different images from both left and right eyes of a user respectively, and finally the user's brain merges the images into a stereo image. In naked-eye stereo display technologies, there are two main types of structures, respectively: lenticular lens and barrier, and some patents related to a 3D image display device using an electrochromic material to achieve the barrier and having a function of switching the display to 3D image or 2D image are listed below:

As disclosed in R.O.C. Pat. No. M368088 entitled “Integrated electrochromic 2D/3D display device, R.O.C. Pat. No. M371902 entitled “Display device for switching 2D image/ 3D image display screen”, R.O.C. Pat. No. 1296723 entitled “Color filter used for 3D image LCD panel manufacturing method thereof”, and U.S. Pat. Application No. 2006087499 entitled Autostereoscopic 3D display device and fabrication method thereof”, electrochromic materials are used as a parallax barrier device for displaying 3D images, but both patents of M368088 and M371902 have a common drawback of lacking a necessary electrolyte layer required by electrochromic devices, since ions are not supplied to the electrolyte layer of the electrochromic layer, and the electrochromic device cannot produce the reversible oxidation or reduction to complete the change of coloration or decoloration, so that the aforementioned patents are not feasible in practical applications. In addition, the transparent electrode layer and electrochromic material layer of the parallax barrier device are grid patterned, and whose manufacturing process requires a precise alignment for coating, spluttering or etching each laminated layer, and thus the manufacturing process is very complicated, and all laminated layers are grid patterned, so that a hollow area is formed between one grid and the other, and the overall penetration, refraction and reflection of the light will be affected. Even for the general 2D display, the video display quality of the display device will be affected to cause problems related to color difference and uneven brightness. The patent 1296723 disclosed an embedded liquid display device (LCD) formed in a structure of a color filter plate, and the electrochromic layer of the aforementioned patents apply electrochromic materials and chromic mechanisms, and thus requiring a greater driving voltage, causing a defect of the material easily, and resulting in a shorter using life.

### SUMMARY OF THE INVENTION

In view of the aforementioned shortcomings, the inventor of the present invention based on years of experience in the related industry to conduct extensive researches and experiments, and finally developed a novel electrochromic module and a display device integrated with the electrochromic module in accordance with the present invention.

Another objective of the present invention is to provide an electrochromic module with a reduced thickness and a simplified manufacturing process.

Another objective of the present invention is to provide an electrochromic module without requiring additional electrolytes.

Another objective of the present invention is to provide an electrochromic module with a quick coloration/decoloration, a long cycle life, and a small driving voltage.

Another objective of the present invention is to provide an electrochromic module having the advantages but not the disadvantages of the organic/inorganic electrochromic materials.

Another objective of the present invention is to provide an electrochromic module capable of deepening the color after the color of the electrochromic material is changed.

To achieve the foregoing objectives, the present invention adopts the following technical measures and provides an electrochromic module

The electrochromic material of the present invention is prepared by dissolving an indicator into a solvent, and the indicator includes a redox indicator, a pH indicator, and etc, and its chromic mechanism provides electrons by using a conductive element, such that the ionic valence of the electrochromic material is changed to change the color of the electrochromic material, particularly in the condition of changing the valence by supplying electrons in a reduction or removing electrons in an oxidation, such that the electrochromism is faster and more uniformly than that of present existing electrochromic materials, and also has the advantages of a smaller driving voltage and a longer life. The electrochromic materials of this sort can be applied for applications in the fields of display device, e-Book, 2D/3D conversion display device, rearview mirror and smart glass.

To achieve the foregoing objectives, the present invention provides an electrochromic module comprising a first transparent substrate, a second transparent substrate, an electrochromic layer formed between the first and second transparent substrates, and a transparent conductive element, wherein the transparent conductive element is installed on the first transparent substrate surface, the second substrate surface, or corresponding opposite surfaces of the first transparent substrate and the second transparent substrate, such that electrons are supplied by the electrochromic layer through the transparent conductive element to change the ionic valence of the structure, so as to perform a color change.

Another structure of the electrochromic module of the present invention comprises a first transparent substrate, a second transparent substrate, an electrochromic layer and an ion layer disposed between the first and second transparent substrates, and a transparent conductive element, the transparent conductive element installed on the first transparent substrate surface, the second substrate surface, or corresponding opposite surfaces of the first transparent substrate and the second transparent substrate, wherein the electrochromic layer is made of a material selected from general organic/inorganic electrochromic materials, and the ion layer is prepared by dissolving an indicator into a solvent and provided for supplying ions to the electrochromic layer. Compared with the color change effect of present existing electrochromic layers combined with a general electrolyte, the color of the electrochromic layer together with the ion layer is darker.

In another preferred embodiment of the present invention, there are two methods of installing the electrochromic module when the electrochromic module is used as a mask of the 3D image display device. The first method replaces the present existing electrolyte layer by the ion layer, and arranges the electrochromic layers with an interval apart from each other in a strip shape, and the ion layer can be packaged between the first transparent substrate and the second transparent substrate, or the position and quantity of the electrochromic layers arranged with an interval apart with each other and with respect to the ion layer can be arranged by packaging a plurality of isolating units between the first transparent substrate and the second transparent substrate. The second method uses the ion layer as the electrochromic layer directly, and a plurality of isolating units to separate the electrochromic layers between the first transparent substrate and the second transparent substrate. Both of the aforementioned methods can use the electrochromic layer to produce a light shield area of the grid, so as to form the barrier.

Another objective of the present invention is to provide a display device using the electrochromic module and providing a function of switching the display of 2D and 3D images.

Another objective of the present invention is to provide a display device that increases the contact area of an electrochromic module and electrodes to improve the speed of changing color.

To achieve the foregoing objectives, the present invention combines the aforementioned electrochromic module with an image display module to produce the display device, such that when the display device is switched from displaying a 2D image to a 3D image, the display image is divided into a left-eye image and a right-eye image. Now, the transparent conductive element is electrically conducted, so that the color of the electrochromic layer is changed from a transparent area to a dark light shield area, and a plurality of light shield areas arranged with an interval apart from each other are produced at the electrochromic module, and an image passing through the light shield areas is divided into a 3D left-eye image and a 3D right-eye image. After our naked eyes receive the image, overlapped patterns will not be produced, since the light shield areas have eliminated a portion of the overlapped image area. In general, a lenticular lens or a barrier is added onto a conventional display device for displaying 3D images, but the electrochromic module and the display device integrated with the electrochromic module in accordance with the present invention directly display the 3D image since the display device has divided the image into the 3D left-eye image and the 3D right-eye image.

### BRIEF DESCRIPTION OF THE DRAWINGS

FIG. 1 is an exploded view of a first preferred embodiment of the present invention;

FIG. 2 is a cross-sectional view of a first preferred embodiment of the present invention;

FIG. 3 is a cross-sectional view of a second preferred embodiment of the present invention;

FIG. 4 is an exploded view of a third preferred embodiment of the present invention;

FIG. 5 is a cross-sectional view of a third preferred embodiment of the present invention;

FIG. 6 is an exploded view of a fourth preferred embodiment of the present invention;

FIG. 7 is a cross-sectional view of a fourth preferred embodiment of the present invention;

FIG. 8 is a cross-sectional view of a fifth preferred embodiment of the present invention;

FIG. 9 is a cross-sectional view of a sixth preferred embodiment of the present invention;

FIG. 10 is a cross-sectional view of a seventh preferred embodiment of the present invention;

FIG. 11 is a cross-sectional view of an eighth preferred embodiment of the present invention;

FIG. 12 is a cross-sectional view of a ninth preferred embodiment of the present invention;

FIG. 13 is a cross-sectional view of a tenth preferred embodiment of the present invention;

FIG. 14 is a cross-sectional view of an eleventh preferred embodiment of the present invention;

FIG. 15 is a cross-sectional view of a twelfth preferred embodiment of the present invention;

FIG. 16 is a cross-sectional view of a thirteenth preferred embodiment of the present invention;

FIG. 17 is a cross-sectional view of a fourteenth preferred embodiment of the present invention;

FIG. 18 is a top view of a structure of transparent conductive elements installed alternately with each other in accordance with the present invention;

FIG. 19 is another top view of a structure of transparent conductive elements installed alternately with each other in accordance with the present invention;

FIG. 20 is an exploded view of a fifteenth preferred embodiment of the present invention;

FIG. 21 is a cross-sectional view of a fifteenth preferred embodiment of the present invention;

FIG. 22 is a cross-sectional view of a sixteenth preferred embodiment of the present invention;

FIG. 23 is a cross-sectional view of a seventeenth preferred embodiment of the present invention; and

FIG. 24 is a cross-sectional view of an eighteenth preferred embodiment of the present invention.

### DETAILED DESCRIPTION OF THE PREFERRED EMBODIMENTS

The technical characteristics and effects of the present invention will be apparent with the detailed description of preferred embodiment together with the illustration of related drawings as follows.

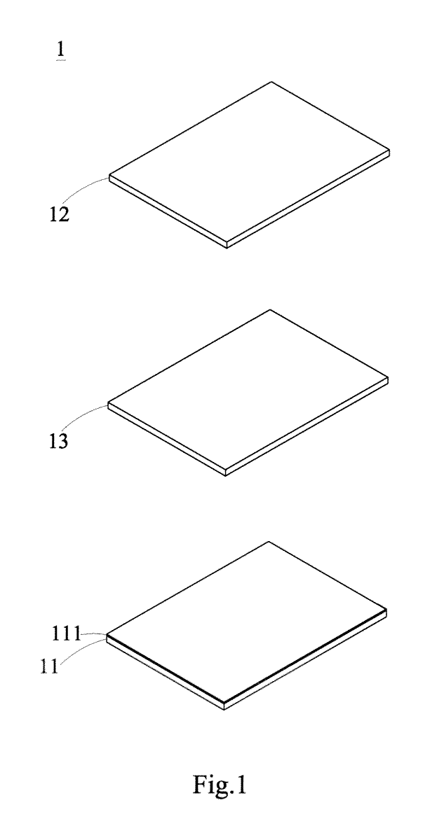

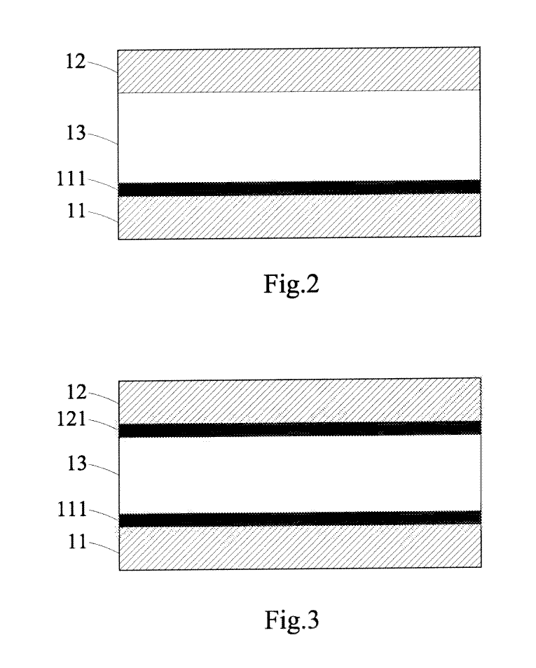

With reference to FIGS. 1 and 2 for an exploded view and a cross-sectional view of a first preferred embodiment of the present invention respectively, an electrochromic module 1 of the present invention comprises a first transparent substrate 11, a second transparent substrate 12 and an electrochromic layer 13.

The first transparent substrate 11 includes a first transparent conductive element 111 on an upper surface of the first transparent substrate 11, and the first transparent substrate 11 and the second transparent substrate 12 are made of a plastic, polymer plastic or glass material, or a plastic polymer selected from the collection of resin, polyethylene (PE), polyethylene terephthalate (PET), polycarbonate (PC), polyethylene (PE), polyvinyl chloride (PVC), polypropylene (PP), polystyrene (PS), and polymethylmethacrylate (PMMA), or a mixture of the above, and the first transparent conductive element 111 is made of an impurity-doped oxide selected from the collection of indium tin oxide (ITO), indium zinc oxide (IZO), Al-doped ZnO (AZO) and antimony tin oxide (ATO), or a carbon nanotube.

The electrochromic layer 13 is disposed between the first transparent substrate 11 and the second transparent substrate 12 and covered onto a surface of the first transparent conductive element 111, and the electrochromic layer 13 is made of a material prepared by mixing an indicator with a solvent, and the electrochromic layer 13 concurrently has the characteristics of oxidation and reduction, and whose color change principle is based on the supply of electrons to the conductive element to change the ionic valence of electrochromic material for the color change, and the concept of supplying electrons to produce a reduction and removing electrons to produce an oxidation. Compared with the conventional way of using the migration of electrons and ions of an electrochromic material to achieve the chromic mechanism, the electrochromism of the present invention is faster and more uniform, and it features a small driving voltage and a long life.

The indicator includes a redox indicator and a pH indicator (or acid-base indicator), etc.

The redox indicator is an indicator used for a redox titration and capable of producing an obvious color change in a specific electrode potential and generally is an organic testing agent having the oxidation and reduction characteristics with different colors under the oxidized and reduced state respectively. Two common types of redox indicators are metal organic compound, and organic oxidation and reduction system. Almost all redox indicators and organic oxidation and reduction systems are related to the application of protons (H⁺) as a reactant of an electrochemical reaction, so that the redox indicator can be divided into two types according to its characteristics: a pH dependent redox indicator and a pH independent redox indicator. The pH independent redox indicator includes: 2,2′-bipyridine, ruthenium complex ions, 5-Nitro-phenanthroline ferrous complex ions, N-Phenylanthranilic acid, 1,10-phenanthroline-ferrous complex ions, erioglaucine disodium salt, paraquat, 2,2′-bipyridine ferrous complex ions, 5,6-phenanthroline-ferrous complex ions, 3,3′-Dimethoxybenzidine, sodium diphenylamine sulfonate, N,N′ diphenylbenzidine, diphenylamine, vioiogen, but some of the aforementioned indicators are toxic; and the dependent pH redox indicator includes dichlorophenolindophenol sodium, o-cresol sodium, thionine, methylene blue, indigo tetrasulfonic acid, indigo trisulfonic acid, indigo carmine, indigo monosulfonic acid, phenol red sodium salt, safranine T, neutral red, etc.

The pH indicator (or acid-base indicator) is a chemical testing agent used for testing the pH value, and a weak acid or a weak alkali containing a pigment, when the pigment of a titrated solution is combined with hydrogen ions or hydroxide ions, the pH indicator is changed to the corresponding acidity or alkalinity to show different colors. Since the pH indicator can produce a reversible color change in solutions of different pH values, therefore the pH value of the testing solution can be detected after the indication reaction ends in a neutralization analysis. Common pH indicators used in laboratories include phenolsulfonphthalein, Congo red, methyl orange, phenolphthalein, thymol blue, litmus, methyl violet, malachite green, methyl yellow, bromophenol blue, bromophenol green, bromophenol green, methyl red, bromcresol purple, bromothymol blue, thymolphthalein, and alizarin yellow R, etc.

The electrochromic layer of a preferred embodiment of the present invention is a redox indicator made by mixing methylene blue (C₁₆H₁₈ClN₃S.3H₂O) and dichlorophenolindophenol sodium (C₁₂H₆Cl₂NNaO₂), or a pH indicator made by mixing variamine blue B diazonium salt (C₁₃H₁₂ClN₃O) with a solvent, and the solvent can be dimethyl sulfoxide ((CH₃)₂SO), propylene carbonate (C₄H₆O₃) or water (H₂O).

The electrochromic layer 13 is usually in a liquid form and can be mixed with an electrically conductive polymer to produce an electrochromic ink to be used together with a screen printing method.

With reference to FIG. 3 for a cross-sectional view of a second preferred embodiment of the present invention, the difference of this preferred embodiment from the first preferred embodiment resides on that a second transparent conductive element 121 is installed at a lower surface of the second transparent substrate 12, and the way of installing the device for supplying electrons differs in the first preferred embodiment and second preferred embodiment, but such arrangement does not affect the chromic mechanism of the electrochromic layer. The concentration of the solvent for dissolving the indication, the potential difference, the solvent polarity, the pH value, the interval between electrodes, and the difference between dielectric constants can be adjusted to control the color display effect of the electrochromic layer 13.

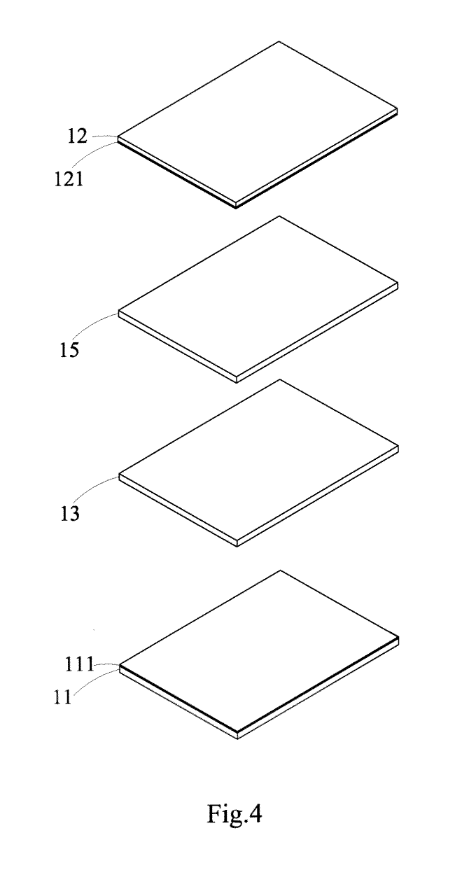

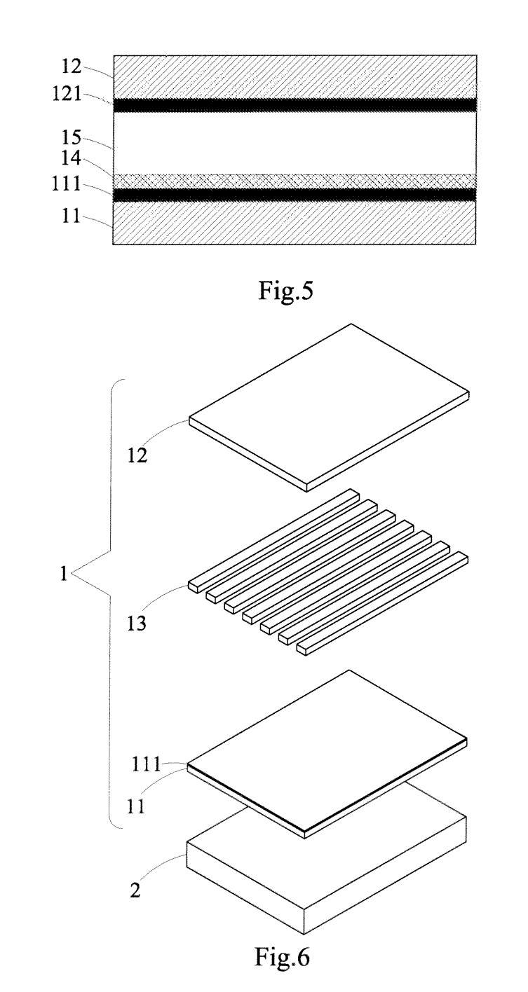

With reference to FIGS. 4 and 5 for an exploded view and a cross-sectional view of a third preferred embodiment of the present invention respectively, the electrochromic layer 13 of the first, second preferred embodiment is made of a material having both oxidation and reduction characteristics, such that the electrochromic layer can be used as the present existing electrochromic material to replace a general electrolyte layer, and the overall color change effect of the electrochromic module 1 is more significant. For example, the electrochromic layer made of WO₃ is operated with a general electrolyte layer, and the oxidized WO₃ is in a blue color, but the ion layer prepared by the material of the present invention allows the electrochromic module to show a better dark blue color.

The electrochromic module 1 of a third preferred embodiment of the present invention comprises a first transparent substrate 11, a second transparent substrate 12, an electrochromic layer 13 and an ion layer 15.

The first transparent substrate 11 includes a first transparent conductive element 111 installed at an upper surface of the first transparent substrate 11, and the second transparent substrate 12 includes a second transparent conductive element 121 installed at a lower surface of the second transparent substrate 12, and the first transparent substrate 11 and the second transparent substrate 12 are made of a plastic, polymer plastic or glass material, or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS), and polymethylmethacrylate (PMMA) or their mixture, and the first transparent conductive element 111 and the second transparent conductive element 121 are made of an impurity-doped oxide selected from the collection of indium tin oxide (ITO), indium zinc oxide (IZO), Al-doped ZnO (AZO) and antimony tin oxide (ATO), or a carbon nanotube.

The electrochromic layers 13 are made of a material selected from the collection of anodic coloration, cathodic coloration, cathodic/anodic coloration transition metal oxides and organic compounds. In general, the anodic coloration material is an anodic coloration transition metal oxide selected from the collection of chromium oxide (Cr₂O₃), nickel oxide (NiOₓ), iridium oxide (IrO₂), manganese oxide (MnO₂), ferric ferrocyanide(Fe₄[Fe(CN)₆]₃) and nickel hydroxide Ni(OH)₂, and the cathodic coloration material is a cathodic coloration transition metal oxide selected from the collection of tungsten oxide (WO₃), molybdenum oxide (MoO₃), niobium oxide (Nb₂O₃), titanium oxide (TiO₂) and strontium titanium oxide (SrTiO₃), and the cathodic/anodic coloration material is a cathodic/anodic coloration transition metal oxide selected from the collection of vanadium pentoxide (V₂O₅), rhodium oxide (Rh₂O₃) and cobalt oxide (CoOₓ) and a transition metal oxide such as tantalum pentoxide (Ta₂O₅) used as a solid electrolyte and an ionic conductive layer.

The ion layer 15 disposed on a surface of the electrochromic layer 13 provides the functions of supplying ions to the electrochromic layer 13, storing the ions and complementing color, and the ion layer 15 is made of a material prepared by mixing an indicator with a solvent, and the indicator includes a redox indicator and a pH indicator (or an acid-base indicator), wherein the indicator of the present invention is preferably prepared by dissolving methylene blue (C₁₆H₁₈ClN₃S.3H₂O), dichlorophenolindophenol sodium (C₁₂H₆Cl₂NNaO₂), variamine blue B, or diazonium salt (C₁₃H₁₂ClN₃O) into a solvent, and the solvent can be dimethyl sulfoxide ((CH₃)₂SO), propylene carbonate (C₄H₆O₃) or water (H₂O).

The electrochromic layer 13 is disposed on the first transparent substrate 11 by using a sol-gel method, a sputtering method, a plating method or a laser etching method, and most of the ion layers 15 are in a liquid form required to be packaged between the first and second transparent substrates 11, 12 and can be mixed with an electrically conductive polymer to produce an electrochromic ink to be used together with a screen printing method.

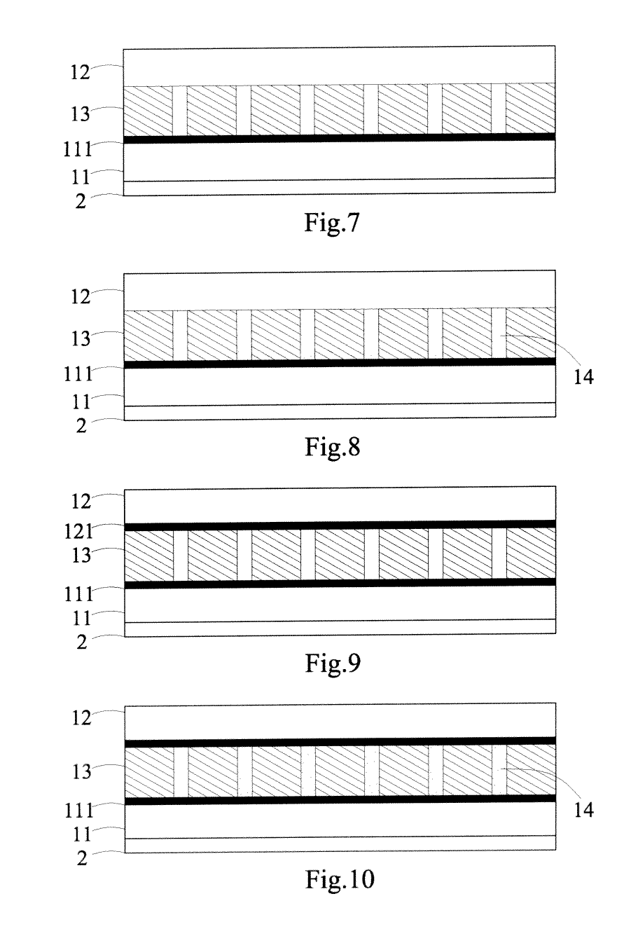

The electrochromic modules of the first, second and third preferred embodiments can be used in the areas of display device, e-Book, 2D/3D display device, rearview mirror and smart glass. With reference to FIGS. 6 and 7 for an exploded view and a cross-sectional view of a fourth preferred embodiment of the present invention respectively, the aforementioned device is used in the application of a 2D/3D display device, and the display device of the present invention is an electrochromic module 1 combined with an image display module 2.

The image display module 2 is used for displaying a 2D image and a 3D image, and the displayed 3D image can be produced by software, firmware or hardware. For example, software or firmware is used to convert the 2D image into an overlapped image including a left-eye image and a right-eye image, and the image display module 2 can be one selected from the collection of a liquid display device (LCD), a plasma display panel (PDP), a surface conduction electron-emitter display (SED), a field emission display (FED), a vacuum fluorescent display (VFD), an organic light-emitting diode (OLED) or e-Paper.

The electrochromic module 1 is combined with a surface of the image display module 2 and comprises a first transparent substrate 11, a second transparent substrate 12 and a plurality of electrochromic layers 13.

The first transparent substrate 11 includes a first transparent conductive element 111 disposed on an upper surface of the first transparent substrate 11, and the first transparent substrate 11, the second transparent substrate 12, and the first transparent conductive element 111 are made of the same materials as described above, and thus will not be repeated here.

The electrochromic layers 13 are made of a material prepared by dissolving an indicator into a solvent, wherein the indicator can be a redox indicator, or a pH indicator (acid-base indicator), etc, and preferably one selected from the collection of methylene blue (C₁₆H₁₈ClN₃S.3H₂O), dichlorophenolindophenol sodium (C₁₂H₆Cl₂NNaO₂), variamine blue B diazonium salt (C₁₃H₁₂ClN₃O), and the solvent can be one selected from the collection of dimethyl sulfoxide ((CH₃)₂SO), propylene carbonate (C₄H₆O₃) and water (H₂O). Compared with the conventional inorganic electrochromic layer, the inorganic electrochromic layer of this concept requires loading both ions and electrons into the crystal lattice, and thus requiring a larger driving voltage, and the solution causes defects to the materials, and the life is approximately equal to ten to twenty thousand times only, and the concept of the present invention simply requires changing the ionic valence of the electrochromic material, not only requiring a small driving voltage and reducing defects of the materials, but also providing a life over thirty thousand times, and the present invention is combined with the image display module to serve as a mask for displaying 2D/3D images, such that the displayed images require high resolution and light transmittance. Compared with the conventional multi-layer electrochromic structure, the electrochromic layer of the present invention does not require combining the electrolyte or other accessory color change layer, so that the thickness can be reduced significantly to improve the light extraction efficiency. The electrochromic layer 13 can be mixed with the electrically conductive polymer to produce an electrochromic ink printed onto an upper surface of the first transparent substrate 11 by a screen printing method and covered onto the first transparent conductive element 111. With reference to FIG. 8 for the cross-sectional view of a fifth preferred embodiment of the present invention, when the electrochromic layers 13 are in a liquid form or a colloidal form, then a plurality of isolating units 14 arranged with an interval apart from each other can be formed between the transparent substrates 11, 12, such that the transparent substrates 11, 12 will produce a plurality of spaces, and the electrochromic layers 13 are disposed in the spaces respectively, wherein the isolating unit 14 is preferably a photoresist.

With reference to FIGS. 9 and 10 for cross-sectional views of sixth and seventh preferred embodiment of the present invention respectively, a second transparent conductive element 121 is installed onto a lower surface of the second transparent substrate 12 of the fourth and fifth preferred embodiments, but the electron supply device of the sixth and seventh preferred embodiments are different from those of the fourth and fifth preferred embodiments, and it does not affect the chromic mechanism of the electrochromic layer. The concentration of the solvent for dissolving the indication, the potential difference, the solvent polarity, the pH value, the interval between electrodes, and the difference between dielectric constants can be adjusted to control the color display effect of the electrochromic layer 13.

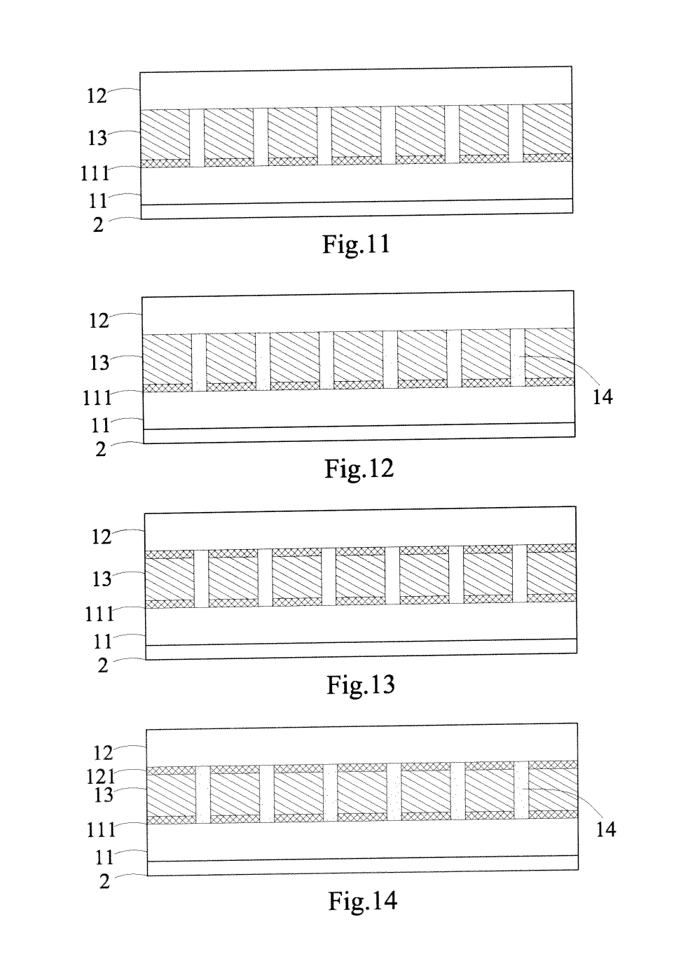

With reference to FIGS. 11 to 14 for cross-sectional view of the eighth to eleventh preferred embodiments of the present invention respectively, the first and second transparent conductive elements 111, 121 arranged with an interval apart from each other as illustrated in the fourth and fifth preferred embodiments are installed on surfaces of the first and second transparent substrates 11, 12 respectively, and correspond to the installation positions and quantity of the electrochromic layers 13, or the first and second transparent conductive elements 111, 121 arranged with an interval apart from each other as illustrated in the sixth and seventh preferred embodiments are installed on surfaces of the first and second transparent substrates 11, 12 respectively, and in the spaces produced by the isolating units 14.

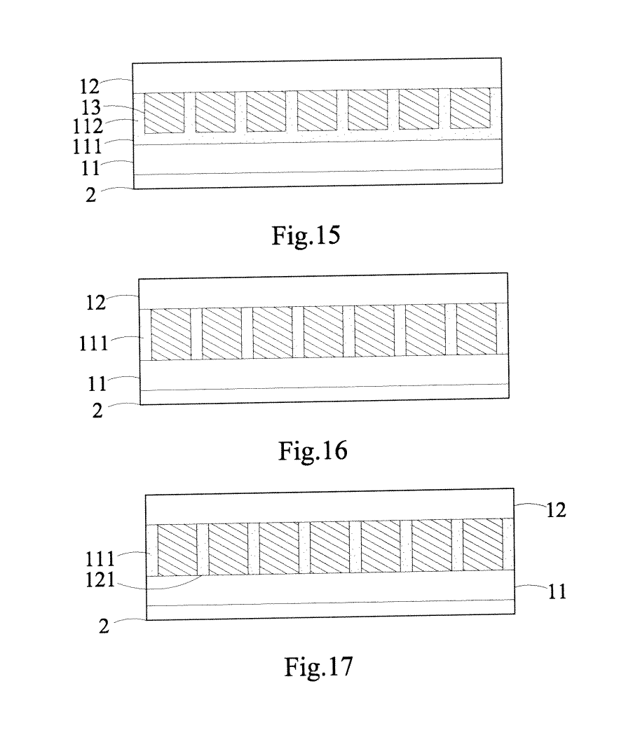

With reference to FIG. 15 for a cross-sectional view of a twelfth preferred embodiment of the present invention, the first transparent conductive element 111 includes a plurality of containing grooves 112, and the electrochromic layers 13 are installed in the containing grooves 112 respectively. Compared with the fifth preferred embodiment that forms the containing grooves 112 on the transparent conductive element 111 without requiring additional installation of the isolating units 14, this preferred embodiment can separate the electrochromic layers 13 into a strip shape, and the electrochromic layer 13 in each containing groove 112 has a plurality of surfaces in contact with the first transparent conductive element 111 to increase the contact area and expedite the response of the color change.

With reference to FIGS. 16 and 17 for cross-sectional views of thirteenth and fourteenth preferred embodiments of the present invention respectively, the first transparent conductive elements 111 of the thirteenth preferred embodiment are arranged with an interval apart from each other and between the first transparent substrate 11 and the second transparent substrate 12, and a plurality of spaces are formed between the first and second transparent substrates 11, 12, and the electrochromic layers 13 are disposed in the spaces respectively. The first transparent conductive elements 111 and the second transparent conductive elements 121 of the fourteenth preferred embodiment as shown in FIG. 17 are arranged with an interval apart from each other and between the first and second transparent substrates 11, 12, such that a plurality of spaces is formed between the first and second transparent substrates 11, 12, and the electrochromic layers 13 are disposed in the spaces respectively. The purpose of the aforementioned arrangement is to use the transparent conductive elements as the isolating units to separate the electrochromic layers 13 into the form of a plurality of strips, and the arrangement provides the electrochromic layer 13 in each space to have two surfaces in contact with the transparent conductive element, so as to increase the contact area and improve the color change speed.

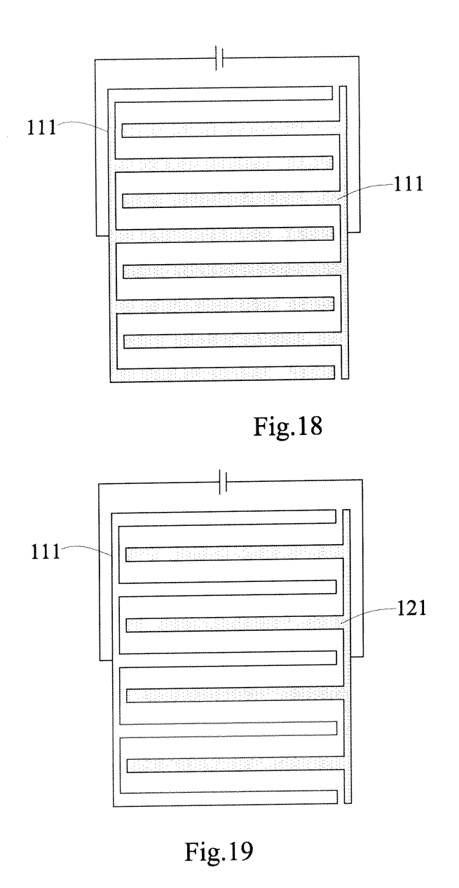

With reference to FIGS. 18 and 19 for top view of a conductive element of the present invention, the twelfth, thirteenth and fourteenth preferred embodiments adopt the transparent conductive elements 111, 121 as the isolating units and arrange the electrochromic layers in the spaces formed by the transparent conductive elements 111, 121, and the way of arranging the transparent conductive elements 111, 121 is shown in the figures, wherein the first transparent conductive elements 111 can be arranged alternately and positive and negative voltages are applied, or the first transparent conductive elements 111 and the second transparent conductive elements 121 are arranged alternately, and a positive voltage is applied to the first transparent conductive elements 111, and a negative voltage is applied to the second transparent conductive elements 121, such that a voltage difference is formed between the strips of the conductive elements. However, the aforementioned arrangement is provided for illustrating the invention only, but not intended to limit the scope of the present invention.

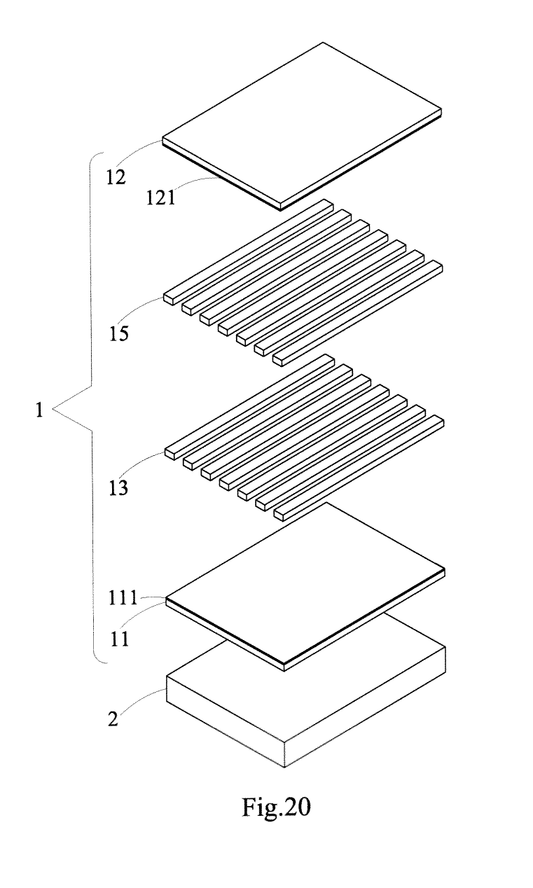

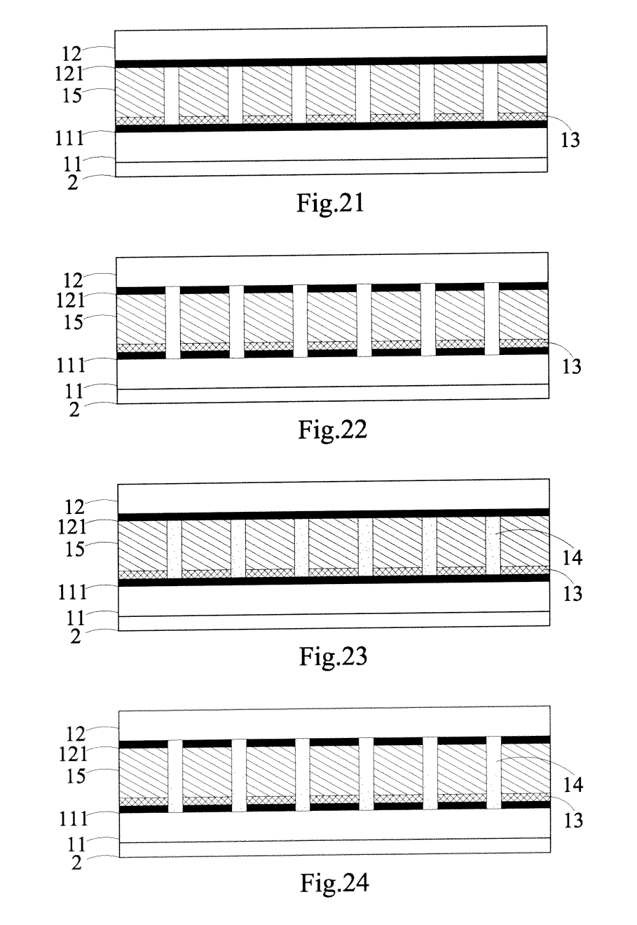

With reference to FIGS. 20 and 21 for an exploded view and a cross-sectional view of a fifteenth preferred embodiment of the present invention respectively, the third preferred embodiment is applied for a 2D/3D display device, and an electrochromic module 1 of the display device of the present invention is combined with an image display module 2.

The image display module 2 is used for displaying a 2D image and a 3D image, and the displayed 3D image can be produced by software, firmware or hardware. For example, software or firmware is used to convert the 2D image into an overlapped image including a left-eye image and a right-eye image, and the image display module 2 can be one selected from the collection of a liquid display device (LCD), a plasma display panel (PDP), a surface conduction electron-emitter display (SED), a field emission display (FED), a vacuum fluorescent display (VFD), an organic light-emitting diode (OLED) or e-Paper.

The electrochromic module 1 is combined with a surface of the image display module 2 and includes a first transparent substrate 11, a second transparent substrate 12, a plurality of electrochromic layers 13 and a plurality of ion layers 15.

The first transparent substrate 11 includes a first transparent conductive element 111 disposed on an upper surface of the first transparent substrate 11, and a second transparent conductive element 121 disposed on a lower surface of the first transparent substrate 11, and the first transparent substrate 11, the second transparent substrate 12, the first transparent conductive element 111 and the second transparent conductive element 121 are made of the same materials as described above, and thus will not be repeated here.

The electrochromic layers 13 are those selected from the collection of anodic coloration, cathodic coloration, cathodic/anodic coloration transition metal oxides or organic compounds, and each group of materials is the same as those described above, and thus will not be repeated here. The electrochromic layers 13 are electrically conducted by the first transparent conductive element 111 and the second transparent conductive element 121 to produce a color change.

The ion layer 15 disposed on a surface of the electrochromic layer 13 provides the functions of supplying ions to the electrochromic layer 13, storing the ions and complementing color, and the ion layer 15 is made of a material prepared by mixing an indicator with a solvent, and the indicator includes a redox indicator and a pH indicator (or an acid-base indicator), wherein the indicator of the present invention is preferably prepared by dissolving methylene blue (C₁₆H₁₈ClN₃S.3H₂O), dichlorophenolindophenol sodium (C₁₂H₆Cl₂NNaO₂), variamine blue B, or diazonium salt (C₁₃H₁₂ClN₃O) into a solvent, and the solvent can be dimethyl sulfoxide ((CH₃)₂SO), propylene carbonate (C₄H₆O₃) or water (H₂O).

The electrochromic layer 13 can be formed on the first transparent substrate 11 by a sol-gel method, a sputtering method, a plating method, or a laser etching method, and most of the ion layers 15 are in the form of a liquid that is required to be packaged between the first and second transparent substrates 11, 12, so that it can be mixed with an electrically conductive polymer to form an electrochromic ink used together with a screen printing method.

With reference to FIG. 22 for a cross-sectional view of a sixteenth preferred embodiment of the present invention, the difference of this preferred embodiment from the fifteenth resides on that the first transparent conductive elements 111 are arranged with an interval apart from each other and on the first transparent substrate 11, and the second transparent conductive elements 121 are arranged with an interval apart from each other and on the second transparent substrate 12.

As described above, the ion layer 15 is in a liquid form or a colloidal form, so that the invention can further arranges a plurality of isolating units 14 with an interval apart from each other and between the first transparent substrate 11 and the second transparent substrate 12, and the isolating unit 14 is preferably a photoresist. With reference to FIG. 23 for a cross-sectional view of a seventeenth preferred embodiment of the present invention, a plurality of isolating units 14 are arranged with an interval apart from each other and between the transparent substrates 11, 12, such that a plurality of spaces is produced between the first and second transparent substrates 11, 12, and the electrochromic layers 14 and the ion layers 15 are disposed in the spaces respectively. With reference to FIG. 24 for a cross-sectional view of an eighteenth preferred embodiment of the present invention, the difference of this preferred embodiment from the sixteenth preferred embodiment resides on that a plurality of isolating units 14 is arranged with an interval apart from each other and between the first and second transparent substrates 11, 12, such that a plurality of spaces is formed between the first and second transparent substrates 11, 12, and the first transparent conductive elements 111, the second transparent conductive elements 121, the electrochromic layers 14, and the ion layers 15 are disposed in the spaces respectively.

In summation of the description above, the electrochromic module 1 in accordance with the fourth to eighteenth preferred embodiments of the present invention is operated together with the image display module 2. In other words, the electrochromic module 1 is installed on an image projecting surface of the image display module 2, such that when an overlapped image (divided into a left-eye image L and a right-eye image R) is processed by the image display module 2, a 3D image is formed while our naked eyes will not receive overlapped patterns due to the light shield areas formed by arranging the electrochromic layers 13 with an interval apart from each other.

While the invention has been described by means of specific embodiments, numerous modifications and variations could be made thereto by those generally skilled in the art without departing from the scope and spirit of the invention set forth in the claims.

What is claimed is:

1. An electrochromic module, comprising:
a first transparent substrate, having at least one first transparent conductive element formed on an upper surface of the first transparent substrate;
a second transparent substrate; and
an electrochromic layer, formed between the first transparent substrate and the second transparent substrate, and made of a material prepared by dissolving an indicator into a solvent.

2. The electrochromic module of claim 1, wherein the first and second transparent substrates are made of a material selected from the collection of plastic, polymer plastic and glass, or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS) and polymethylmethacrylate (PMMA).

3. The electrochromic module of claim 1, wherein the first transparent conductive element is made of an impurity-doped oxide selected from the collection of indium tin oxide (ITO), indium zinc oxide (IZO), Al-doped ZnO (AZO) and antimony tin oxide (ATO).

4. The electrochromic module of claim 1, wherein the first transparent conductive element is made of a carbon nanotube.

5. The electrochromic module of claim 1, wherein the indicator is a redox indicator or a pH indicator.

6. The electrochromic module of claim 5, wherein the redox indicator is methylene blue or dichlorophenolindophenol sodium.

7. The electrochromic module of claim 5, wherein the pH indicator is a variamine blue B diazonium salt.

8. The electrochromic module of claim 1, wherein the solvent is dimethyl sulfoxide, propylene carbonate or water.

9. The electrochromic module of claim 1, wherein the first transparent conductive elements are arranged with an interval apart from each other on the first transparent substrate, when there is a plurality of first transparent conductive elements.

10. An electrochromic module, comprising:
a first transparent substrate, having a first transparent conductive element disposed on an upper surface of the first transparent substrate;
a second transparent substrate, having a second transparent conductive element disposed on a lower surface of the second transparent substrate;
an electrochromic layer, formed between the first transparent conductive element and the second transparent conductive element, for producing a coloration according to the electric conduction of the first and second transparent conductive elements; and
an ion layer, formed on a surface of the electrochromic layer, and made of a material prepared by dissolving an indicator into a solvent.

11. The electrochromic module of claim 10, wherein the first and second transparent substrates are made of a material selected from the collection of plastic, polymer plastic and glass, or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS) and polymethylmethacrylate (PMMA).

12. The electrochromic module of claim 10, wherein the first transparent conductive element is made of an impurity-doped oxide selected from the collection of indium tin oxide (ITO), indium zinc oxide (IZO) and Al-doped ZnO (AZO) and antimony tin oxide (ATO).

13. The electrochromic module of claim 10, wherein the first transparent conductive element is made of a carbon nanotube.

14. The electrochromic module of claim 10, wherein the electrochromic layer is an anodic coloration electrochromic layer, a cathodic coloration electrochromic layer or a cathodic/anodic coloration electrochromic layer.

15. The electrochromic module of claim 14, wherein the anodic coloration electrochromic layer is made of an anodic coloration transition metal oxide selected from the collection of chromium oxide (Cr₂O₃), nickel oxide (NiOₓ), iridium oxide (IrO₂), manganese oxide (MnO₂), nickel hydroxide[Ni(OH)₂], tantalum pentoxide (Ta₂O₅) and ferric ferrocyanide (Fe₄[Fe(CN)₆]₃).

16. The electrochromic module of claim 14, wherein the cathodic coloration electrochromic layer is a cathodic coloration transition metal oxide selected from the collection of tungsten oxide (WO₃), molybdenum oxide (MoO₃), niobium oxide (Nb₂O₃), titanium oxide (TiO₂), strontium titanium oxide (SrTiO₃) and tantalum pentoxide (Ta₂O₅).

17. The electrochromic module of claim 14, wherein the cathodic/anodic coloration electrochromic layer is made of a cathodic/anodic coloration transition metal oxide selected from the collection of vanadium oxide (V₂O₂), rhodium oxide (Rh₂O₃) and cobalt oxide (CoOₓ).

18. The electrochromic module of claim 10, wherein the indicator is a redox indicator or a pH indicator.

19. The electrochromic module of claim 18, wherein the redox indicator is methylene blue (C₁₆H₁₈ClN₃S.3H₂O) or dichlorophenolindophenol sodium (C₁₂H₆Cl₂NNaO₂).

20. The electrochromic module of claim 18, wherein the pH indicator is a variamine blue B diazonium salt (C₁₃H₁₂ClN₃O).

21. The electrochromic module of claim 10, wherein the solvent is dimethyl sulfoxide [(CH₃)₂SO], propylene carbonate (C₄H₆O₃) or water.

22. A display device, comprising:
an image display module, for displaying a planar image and a 3D image;
an electrochromic module, installed on a surface of the image display module, and including:
a first transparent substrate, having at least one first transparent conductive element disposed on a surface of the first transparent substrate;
a second transparent substrate; and
a plurality of electrochromic layers, arranged with an interval apart from each other and between the first transparent substrate and the second transparent substrate, and made of a material prepared by dissolving an indicator into a solvent.

23. The display device of claim 22, wherein the electrochromic layers is further mixed with a conductive polymer material.

24. The display device of claim 23, wherein the plurality of electrochromic layers is formed on the first transparent substrate surface by a screen printing method.

25. The display device of claim 22, wherein the first and second transparent substrates are made of a material selected from the collection of plastic, polymer plastic and glass, or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS) and polymethylmethacrylate (PMMA).

26. The display device of claim 22, wherein the first transparent conductive element is made of an impurity-doped oxide selected from the collection of indium tin oxide (ITO), indium zinc oxide (IZO), Al-doped ZnO (AZO) and antimony tin oxide (ATO).

27. The display device of claim 22, wherein the first transparent conductive element is made of a carbon nanotube.

28. The display device of claim 22, wherein the indicator is a redox indicator or a pH indicator.

29. The display device of claim 28, wherein the redox indicator is methylene blue (C₁₆H₁₈ClN₃S.3H₂O) or dichlorophenolindophenol sodium (C₁₂H₆Cl₂NNaO₂).

30. The display device of claim 28, wherein the pH indicator is a variamine blue B diazonium salt (C₁₃H₁₂ClN₃O).

31. The display device of claim 22, wherein the solvent is dimethyl sulfoxide [(CH₃)₂SO], Propylene carbonate (C₄H₆O₃) or water.

32. The display device of claim 22, further comprising at least one second transparent conductive element disposed on a surface of the second transparent substrate.

33. The display device of claim 22, wherein the first transparent conductive elements are arranged with an interval apart from each other on the first transparent substrate, when there is a plurality of first transparent conductive elements.

34. The display device of claim 33, wherein the plurality of electrochromic layers is disposed between the first transparent conductive elements.

35. The display device of claim 22, wherein the first transparent conductive element further includes a plurality of containing grooves, and the electrochromic layers are disposed in the containing grooves.

36. The display device of claim 32, wherein the second transparent conductive elements are arranged with an interval apart from each other on the second transparent substrate, when there is a plurality of second transparent conductive elements.

37. The display device of claim 22, wherein the plurality of transparent substrates further includes a plurality of isolating units arranged with an interval apart from each other, and the electrochromic layers are disposed between the isolating units.

38. The display device of claim 37, wherein the isolating units are photoresists.

39. The display device of claim 32, wherein first transparent conductive elements and second transparent conductive elements are arranged sequentially between the first and second transparent substrates when there is a plurality of first transparent conductive elements and second transparent conductive elements, and the electrochromic layers are disposed between one of the first transparent conductive elements and one of the second transparent conductive elements.

40. A display device, comprising:
an image display module, for displaying a planar image and a 3D image;
an electrochromic module, installed on a surface of the image display module, and including:
a first transparent substrate, having a plurality of first transparent conductive elements arranged with an interval apart from each other on a surface of the first transparent substrate;
a second transparent substrate;
a plurality of electrochromic layers, formed between the first transparent conductive elements and the second transparent substrate, and made of a material prepared by dissolving an indicator into a solvent; and
a plurality of isolating units, disposed between the electrochromic layers.

41. The display device of claim 40, wherein each of the electrochromic layers is further mixed with a conductive polymer material.

42. The display device of claim 41, wherein the electrochromic layers are formed on the first transparent substrate surface by a screen printing method.

43. The display device of claim 40, wherein the plurality of transparent substrates is made of a material selected from the collection of plastic, polymer plastic and glass, or a plastic polymer selected from the collection of resin, polyethylene (PE) polyethylene terephthalate (PET), polycarbonate (PC), polyethylene (PE), polyvinyl chloride (PVC), polypropylene (PP) and polystyrene (PS), polymethylmethacrylate (PMMA).

44. The display device of claim 40, wherein the first transparent conductive element is made of an impurity-doped oxide selected from the collection of indium tin oxide (ITO), indium zinc oxide (IZO), Al-doped ZnO (AZO) and antimony tin oxide (ATO).

45. The display device of claim 40, wherein the first transparent conductive element is made of a carbon nanotube.

46. The display device of claim 40, wherein the indicator is a redox indicator or a pH indicator.

47. The display device of claim 45, wherein the redox indicator is methylene blue (C₁₆H₁₈ClN₃S.3H₂O) or dichlorophenolindophenol sodium (C₁₂H₆Cl₂NNaO₂).

48. The display device of claim 45, wherein the pH indicator is a variamine blue B diazonium salt (C₁₃H₁₂ClN₃O).

49. The display device of claim 40, wherein the solvent is dimethyl sulfoxide [(CH₃)₂SO], propylene carbonate (C₄H₆O₃) or water.

50. The display device of claim 40, further comprising a plurality of second transparent conductive elements arranged with an interval apart from each other on a lower surface of the second transparent substrate.

51. The display device of claim 40, wherein the plurality of isolating units is a photoresist.

52. A display device, comprising:
an image display module, for displaying a planar image and a 3D image;
an electrochromic module, installed on a surface of the image display module, and including:
a first transparent substrate, having a plurality of first transparent conductive elements disposed on a surface of the first transparent substrate;
a second transparent substrate, having a plurality of second transparent conductive elements disposed on a surface of the second transparent substrate;
a plurality of electrochromic layers, disposed between the first transparent conductive elements and the second transparent conductive elements, for producing a coloration according to the electric conduction of the first and second transparent conductive elements; and
a plurality of ion layers, formed on surfaces of the electrochromic layers, and made of a material prepared by dissolving an indicator into a solvent.

53. The display device of claim 52, wherein the plurality of electrochromic layers is further mixed with a conductive polymer material.

54. The display device of claim 52, wherein the plurality of electrochromic layers is formed on the first substrate surface by a screen printing method.

55. The display device of claim 52, wherein the plurality of transparent substrates is made of a material selected from the collection of plastic, polymer plastic and glass, or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS) and polymethylmethacrylate (PMMA).

56. The display device of claim 52, wherein the first transparent conductive element is made of an impurity-doped oxide selected from the collection of indium tin oxide (ITO), indium zinc oxide (IZO), Al-doped ZnO (AZO) and antimony tin oxide (ATO).

57. The display device of claim 52, wherein the first transparent conductive element is made of a carbon nanotube.

58. The display device of claim 52, wherein the electrochromic layers are anodic coloration electrochromic layers, cathodic coloration electrochromic layers or cathodic/anodic coloration electrochromic layers.

59. The display device of claim 58, wherein the anodic coloration electrochromic layers are anodic coloration transition metal oxides selected from the collection of chromium oxide (Cr₂O₃), nickel oxide (NiOₓ), iridium oxide (IrO₂), manganese oxide (MnO₂), nickel hydroxide [Ni(OH)₂], tantalum pentoxide (Ta₂O₅) and ferric ferrocyanide (Fe₄[Fe(CN)₆]₃).

60. The display device of claim 58, wherein the cathodic coloration electrochromic layers are made of cathodic coloration transition metal oxides selected from the collection of tungsten oxide (WO₃), molybdenum oxide (MoO₃), niobium oxide (Nb₂O₃), titanium oxide (TiO₂), strontium titanium oxide (SrTiO₃) and tantalum pentoxide (Ta₂O₅).

61. The display device of claim 58, wherein the cathodic/anodic coloration electrochromic layers are made of cathodic/anodic coloration transition metal oxides selected from the collection of vanadium oxide (V₂O₂), rhodium oxide (Rh₂O₃) and cobalt oxide (CoOₓ).

62. The display device of claim 52, wherein the indicator is a redox indicator or a pH indicator.

63. The display device of claim 62, wherein the redox indicator is methylene blue (C₁₆H₁₈ClN₃S.3H₂O) or dichlorophenolindophenol sodium (C₁₂H₆Cl₂NNaO₂).

64. The display device of claim 62, wherein the pH indicator is a variamine blue B diazonium salt (C₁₃H₁₂ClN₃O).

65. The display device of claim 52, wherein the solvent is dimethyl sulfoxide [(CH₃)₂SO], propylene carbonate (C₄H₆O₃) or water.

66. The display device of claim 52, wherein the first transparent conductive elements and the second transparent conductive elements are arranged with an interval apart from each other on the first and second transparent substrate surfaces.

67. The display device of claim 52, wherein the plurality of transparent substrates further comprises a plurality of isolating unit arranged with an interval apart from each other, and the electrochromic layers and the ion layers are disposed between the isolating units.

68. The display device of claim 67, wherein the isolating units are photoresists.

69. A display device, comprising:
an image display module, for displaying a planar image and a 3D image;
an electrochromic module, installed on a surface of the image display module, and including:
a first transparent substrate, having a plurality of first transparent conductive elements arranged with an interval apart from each other on a surface of the first transparent substrate;
a second transparent substrate, having a plurality of second transparent conductive elements arranged with an interval apart from each other on a surface of the second transparent substrate;
a plurality of electrochromic layers, formed between the first and second transparent conductive elements, for producing a coloration according to the electric conduction of the first and second transparent conductive elements;
a plurality of isolating units, disposed between the electrochromic layers; and
a plurality of ion layers, formed on surfaces of the electrochromic layers, and the electrochromic layers being prepared by dissolving an indicator into a solvent.

70. The display device of claim 69, wherein the plurality of electrochromic layers is further mixed with a conductive polymer material.

71. The display device of claim 70, wherein the electrochromic layers are formed on the first transparent substrate surface by a screen printing method.

72. The display device of claim 69, wherein the transparent substrates are made of material selected from the collection of plastic, polymer plastic and glass or a plastic polymer selected from the collection of resin, polyethylene (PE) polyethylene terephthalate (PET), polycarbonate (PC), polyethylene (PE), polyvinyl chloride (PVC), polypropylene (PP), polystyrene (PS) and polymethylmethacrylate (PMMA).

73. The display device of claim 69, wherein the plurality of first and second transparent conductive elements are made of an impurity-doped oxides selected from the collection of indium tin oxide (ITO), indium zinc oxide (IZO), Al-doped ZnO (AZO) and antimony tin oxide (ATO).

74. The display device of claim 69, wherein the first and second transparent conductive elements are made of carbon nanotubes.

75. The display device of claim 69, wherein the electrochromic layers are anodic coloration electrochromic layers, cathodic coloration electrochromic layers or cathodic/anodic coloration electrochromic layers.

76. The display device of claim 75, wherein the anodic coloration electrochromic layers are made of anodic coloration transition metal oxides selected from the collection of chromium oxide(Cr₂O₃), nickel oxide(NiOₓ), iridium oxide (IrO₂), manganese oxide (MnO₂), nickel hydroxide [Ni(OH)₂], tantalum pentoxide (Ta₂O₅) and ferric ferrocyanide (Fe₄[Fe(CN)₆]₃).

77. The display device of claim 75, wherein the cathodic coloration electrochromic layers are made of cathodic coloration transition metal oxides selected from the collection of tungsten oxide (WO₃) , molybdenum oxide (MoO₃), niobium oxide (Nb₂O₃), titanium oxide (TiO₂), strontium titanium oxide (SrTiO₃) and tantalum pentoxide (Ta₂O₅).

78. The display device of claim 75, wherein the cathodic/anodic coloration electrochromic layers are made of cathodic/anodic coloration transition metal oxides selected from the collection of vanadium oxide (V₂O₂), rhodium oxide (Rh₂O₃) and cobalt oxide (CoOₓ).

79. The display device of claim 69, wherein the indicator is a redox indicator or a pH indicator.

80. The display device of claim 79, wherein the redox indicator is methylene blue (C₁₆H₁₈ClN₃S.3H₂O) or dichlorophenolindophenol sodium (C₁₂H₆Cl₂NNaO₂).

81. The display device of claim 79, wherein the pH indicator is a variamine blue B diazonium salt (C₁₃H₁₂ClN₃O).

82. The display device of claim 69, wherein the solvent is dimethyl sulfoxide [(CH₃)₂SO], propylene carbonate (C₄H₆O₃) or water.

83. The display device of claim 69, wherein the isolating units are photoresists.
